(19) United States
(12) Patent Application Publication
(10) Pub. No.: US 2025/0241388 A1
(43) Pub. Date: Jul. 31, 2025

(54) SELF-ADHESIVE FABRIC

(71) Applicant: Shawn Shoulders, Lafayette, TN (US)

(72) Inventor: Shawn Shoulders, Lafayette, TN (US)

(21) Appl. No.: 18/424,064

(22) Filed: Jan. 26, 2024

(51) Int. Cl. A41D 27/12; C09J 7/29

(52) U.S. Cl. CPC A41D 27/12; C09J 7/29; C09J 2203/358

(57) ABSTRACT

A self-adhesive fabric is disclosed, including a front side to collect a substance and prevent the substance from contacting a garment. A back side includes an adhesive, the adhesive to adhere to the garment. The self-adhesive fabric can be applied to a region of the garment to protect the garment from substances which may soil the garment.

### TECHNICAL FIELD

The embodiments disclosed herein generally relate to adhesive fabric and more particularly to adhesive fabrics which can adhered placed on a garment.

### BACKGROUND

It is common for clothing to become dirty, especially during projects. For example, painting is notoriously messy, and it is not uncommon for wet paint to contact the garment due to splatter or contact with a newly-painted surface. This can lead to the garment being ruined at worst, and at best the garment needed to be washed in order to remove the paint. While painting is a particular example, it can be seen that it is common for clothing to become dirty due to various reasons.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a self-adhesive fabric is disclosed, including a front side to collect a substance and prevent the substance from contacting a garment. A back side includes an adhesive, the adhesive to adhere to the garment. The self-adhesive fabric can be applied to a region of the garment to protect the garment from substances which may soil the garment.

The self-adhesive fabric can be efficiently and readily applied to the garment while the user is performing tasks which raise the likelihood of the garment becoming spoiled. Examples of tasks include mechanical work, painting, landscaping, and other trade work.

In one aspect, a decorative element may be applied to the front side of the self-adhesive fabric to allow the user to selectively style themselves while wearing the self-adhesive fabric on a garment.

In one aspect, the self-adhesive fabric includes a texture applied to the front side.

In one aspect, the self-adhesive fabric includes a protective film applied to the back side to preserve the adhesive prior to use. The protective film may be easily removed prior to adhering the self-adhesive fabric to the garment.

In one aspect, the fabric is a moisture wicking fabric, or may include a moisture repellant.

In one aspect, the fabric has insulative properties to provide selectively positioned insulation. This may be especially useful in cold environments.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a front elevation view of the front side of the self-adhesive fabric, according to some embodiments;

FIG. 2 illustrates a front elevation view of the back side of the self-adhesive fabric, according to some embodiments;

FIG. 3 illustrates an exploded view of the self-adhesive fabric, according to some embodiments;

FIG. 4 illustrates a perspective view of the self-adhesive fabric attached to a pair of pants, according to some embodiments; and

FIG. 5 illustrates a perspective view of the self-adhesive fabric attached to a shirt, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a self-adhesive fabric which is adhered to a garment to protect the garment from spills, dirt, and general soiling. The embodiments can be particularly useful for painters or other laborers who have a high probability of dirtying their garments throughout the workday. However, the self-adhesive fabric may be applied by anyone wanting to protect their garments throughout the day or during specific times when there is a likelihood of soiling the garment. The self-adhesive fabric includes a rear side having an adhesive applied thereto. The adhesive adheres the self-adhesive fabric to the garment and maintain the self-adhesive fabric in a fixed position on the garment. A front side includes a protective surface.

The self-adhesive fabric can be applied to any location on the garment. In some instances, multiple self-adhesive fabrics can be used in tandem to protect a large area of the garment. The adhesive is strong enough to adhere to any type of fabric including cotton, cotton blends, denim, nylon, leather, and other textiles used in the construction of garments.

In some embodiments, the front side of the self-adhesive fabric can include moisture-wicking fabrics to absorb moisture into the front side of the self-adhesive fabric.

In some embodiments, the front side of the self-adhesive fabric can include a moisture repellant to repel and thus prevent the absorption of moisture into the fabric.

In some embodiments, a barrier is positioned between the front side of the self-adhesive fabric and the rear-side of the self-adhesive fabric. The barrier can prevent seepage of moisture into the adhesive layer of the self-adhesive fabric and thus ensure the adhesive qualities are preserved.

FIG. 1 illustrates a front elevation view of the front side 100 of the self-adhesive fabric 10. The front side 100 includes a fabric 101 which is able to capture, collect, retain, and protect the underlying garment from soiling. The fabric 101 may be similar to a paper towel, towel, or other absorbent fabric. The fabric 101 can be constructed in any shape, size, or configuration to sufficiently protect the garment from soiling. A texture 103 may be applied to the front side 100 to help capture dirt and dust. Alternatively, a microfiber material may be applied for specific use cases (e.g., capturing dust).

In some embodiments, the self-adhesive fabric 10 can be cut or trimmed by the user to suitably fit the garments. The self-adhesive fabric 10 can be provided as a set or kit including various sizes, shapes, and configurations. Further the self-adhesive fabric 10 may be provided having multiple fabric options for the front side 100 to allow the user to select an optimal material for different use cases. For example, a specific material may be optimal for plumbing, while other materials may be best suited for painting, mechanical work, landscaping, etc.

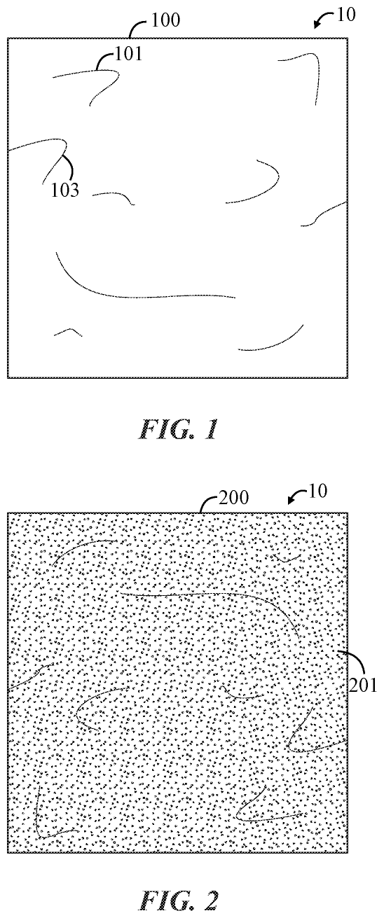

FIG. 2 illustrates a front elevation view of the back side 200 of the self-adhesive fabric 10. The back side 200 includes an adhesive 201 which is capable of being adhered to a garment (e.g., shirts, jackets, sweatshirts, pants, shorts, etc.). The adhesive 201 may be any self-adhesive compound known in the arts which is capable of retaining the self-adhesive fabric 10 in a fixed position on the garment throughout the day and for extended periods of time. The adhesive 201 allows for the self-adhesive fabric 10 to be readily removed and replaced. The adhesive 201 should be one that does not damage the garment or leave a residue on the garment following use.

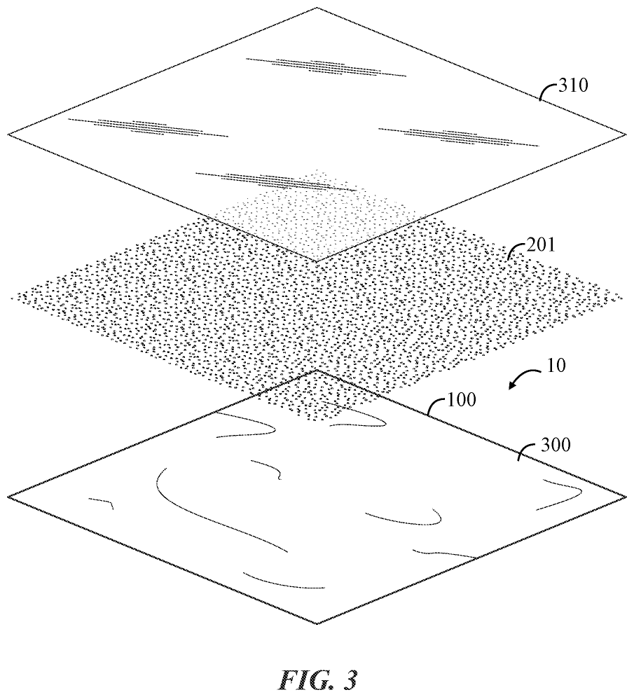

FIG. 3 illustrates an exploded view of the self-adhesive fabric 10. The back side 200 is bonded to the front side 100 such that the adhesive 201 is attached to the front side 100. This can be accomplished by various means known in the arts. In some embodiments, the adhesive 201 is applied to a rear side 300 of the front side 100 of the self-adhesive fabric. The adhesive 201 may be applied by various means known in the arts. A protective film 310 is provided to protect the adhesive from degradation prior to use. Once the protective film 310 is applied during manufacturing, the adhesive 201 is positioned between he protective film 310 and front side 100, thus protecting the adhesive 201 by enclosing it therebetween the two components.

In some embodiments, a protective film may be provided over the adhesive 201 to preserve its adhesive qualities prior to use. During use, the user would remove the protective film before applying the self-adhesive fabric 10 to the garment.

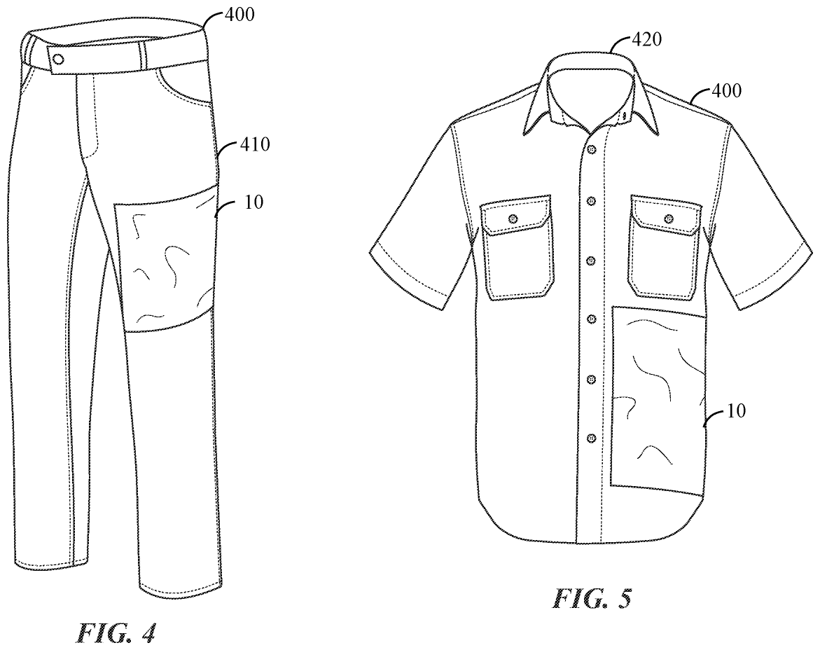

FIG. 4 illustrates the self-adhesive fabric 10 attached to a garment 400 wherein the illustrates example shows the garment being pants 410. Similarly, FIG. 5 illustrates the self-adhesive fabric 10 attached to a garment 400 wherein the illustrated example shows the garment being a shirt 420. It is to be understood that the self-adhesive fabric 10 can be positioned on any portion of the garment. A plurality of self-adhesive fabrics 10 as described herein can be positioned on the same garment to provide additional coverage and protection.

In some embodiments, for example, the self-adhesive fabric 10 is constructed of a flexible material such that it may be positioned on the portion of the garment corresponding to the user's knees, elbows, shoulders, etc.

In some embodiments, the adhesive is non-permanent and non-marking so an integrity of the garment where it is affixed is preserved, yet strong enough to resist shear forces or other forces which would remove the self-adhesive fabric from the garment, or otherwise compromise the integrity of the adhesion between the self-adhesive fabric and the garment.

A variety of adhesives are commercially available and can be used as the adhesive layer(s) described above. As noted above, an adhesive, such as a web adhesive, a powder adhesive, or a micro-dot adhesive, can be pre-applied on the back side.

In some embodiments, the self-adhesive fabric may have insulative qualities to provide insulation in cold environments. In such, the user can apply the self-adhesive fabric to insulate specific regions of the garment, while also protecting the garment from soiling.

In some embodiments, a pattern, image, texture, or other decorative element is provided on the front side 100 of the self-adhesive fabric 10. In such, the user can selectively style the garment using the self-adhesive fabric.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A self-adhesive fabric, comprising:
a moisture repellant front side fabric configured to collect a substance and prevent the substance from contacting a garment; and
a back side including an adhesive comprising at least one of a web adhesive, a powder adhesive, or a micro-dot adhesive, the adhesive configured to adhere to the garment without damaging or leaving residue on the garment when removed.

2. The self-adhesive fabric of claim 1, further comprising a texture applied to the front side.

3. The self-adhesive fabric of claim 1, further comprising a removable protective film configured to preserve the adhesive.

4. The self-adhesive fabric of claim 1, further comprising a decorative element applied to the front side.

5. The self-adhesive fabric of claim 1, wherein the front side comprises a fabric.

6. The self-adhesive fabric of claim 5, wherein the fabric is a moisture wicking fabric.

7. The self-adhesive fabric of claim 6, wherein the fabric is configured to collect dirt or dust.

8. (canceled)

9. The self-adhesive fabric of claim 5, wherein the fabric has insulative properties to provide insulation.

10. A self-adhesive fabric, comprising:
a moisture repellant front side fabric configured to collect a substance and prevent the substance from contacting a garment;
a back side including an adhesive comprising at least one of a web adhesive, a powder adhesive, or a micro-dot adhesive, the adhesive configured to adhere to the garment without damaging or leaving residue on the garment when removed; and
a protective film configured to protect the adhesive prior to the application of self-adhesive fabric to the garment.

11. The self-adhesive fabric of claim 10, further comprising a texture applied to the front side.

12. The self-adhesive fabric of claim 10, further comprising a protective film applied to the back side.

13. The self-adhesive fabric of claim 10, further comprising a protective film configured to preserve the adhesive.

14. The self-adhesive fabric of claim 10, further comprising a decorative element applied to the front side.

15. The self-adhesive fabric of claim 10, wherein the front side comprised a fabric.

16. The self-adhesive fabric of claim 15, wherein the fabric is a moisture wicking fabric.

17. The self-adhesive fabric of claim 16, wherein the fabric collects dirt or dust.

18. (canceled)

19. The self-adhesive fabric of claim 15, wherein the fabric has insulative properties to provide insulation.

20. The self-adhesive fabric of claim 10, wherein the garment is selected from one of the following: a pair of paints, a shirt, a sweatshirt, and a pair of shorts.
